(19) United States
(12) Patent Application Publication
(10) Pub. No.: US 2025/0252394 A1
(43) Pub. Date: Aug. 7, 2025

(54) RFID-BASED PRODUCT IDENTIFICATION AND DIGITALIZATION SYSTEMS AND METHODS FOR NON-DIGITAL PRODUCTS

(71) Applicant: Power Home Remodeling Group, LLC, Chester, PA (US)

(72) Inventor: Timothy Wenhold, Collegeville, PA (US)

(21) Appl. No.: 19/029,376

(22) Filed: Jan. 17, 2025

Related U.S. Application Data
(60) Provisional application No. 63/549,600, filed on Feb. 5, 2024.

(51) Int. Cl. G06Q 10/087; G06K 7/10

(52) U.S. Cl. CPC G06Q 10/087; G06K 7/10386

(57) ABSTRACT

Systems and methods for identification and tracking of physical objects are disclosed. In some embodiments, a system may include a physical product having a product identification tag. The product identification tag may be configured to wirelessly transmit identification data associated with the physical product. The system may also include a management server. The management server may also store project information associated with the physical product and associate the identification data with the project information. The system may also include one or more client devices communicatively coupled to the management server. The one or more client devices may be configured to wirelessly obtain the identification data from the product identification tag when in proximity to the product identification tag and communicate the identification data to the management server.

### CROSS-REFERENCE TO RELATED APPLICATIONS

This application claims the benefit of priority under 35 U.S.C. § 119(e) to prior U.S. Provisional Patent Application No. 63/549,600 filed on Feb. 5, 2024, the disclosure of which is incorporated by reference herein in its entirety.

### FIELD OF DISCLOSURE

The present disclosure generally relates to the technical field of home improvements. More specifically, the disclosed systems and methods relate to identification and tracking of physical objects that are used in home improvements.

### BACKGROUND

It has traditionally been a challenge to manage and track non-digital products, such as window sashes, used in home improvement (or even new construction) projects. Businesses often face difficulties in accurately monitoring their inventory, offering warranties, and managing sales records for these products. Further, customers have not previously been involved in the management and tracking of such products.

There is a need to develop improved systems and methods for managing and tracking physical products used in home improvement (or new construction) projects.

### SUMMARY

In some embodiments, a system may include a physical product having a product identification tag. The product identification tag may be configured to wirelessly transmit identification data associated with the physical product. The system may also include a management server. The management server may also store project information associated with the physical product and associate the identification data with the project information. The system may also include one or more client devices communicatively coupled to the management server. The one or more client devices may be configured to wirelessly obtain the identification data from the product identification tag when in proximity to the product identification tag and communicate the identification data to the management server.

In some embodiments, the physical product may be a window installed at a customer location. In some embodiments, the product identification tag may be a radio-frequency identification (RFID) tag and the one or more client devices may be a radio frequency (RF) reader enabled device. In some embodiments, the project information may include one or more of the physical product's purchase date, manufacturing status, installation date, installed location, model, specification, serial number, project number, maintenance history, and warranty information.

In some embodiments, the one or more client devices may include a software application for execution on a smart phone or a tablet. In some embodiments, the software application may include a service or a warranty service request feature. In some embodiments, the one or more client devices may be configured to display to a user the project information retrieved by the management server using the identification data. In some embodiments, the one or more client devices may be a smart phone or a tablet. In some embodiments, the product identification tag may be attached to a surface of the physical product. In some embodiments, the product identification tag may be embedded in the physical product.

In some embodiments, a method may include receiving through a network identification data. The identification data may be read wirelessly from a product identification tag with a client device. The client device may have an application thereon for instructing a user in performing the reading. The product identification tag may be attached to a physical product installed at a residence. The method may also include checking the received identification data against stored project information associated with the installed physical product. The method may also include based on the checking, identifying the physical product. The method may also include for the identified physical product, receiving from the client device a service or a warranty request.

In some embodiments, the physical product may be a window. In some embodiments, the product identification tag may be a radio-frequency identification (RFID) tag and the client device may be a radio frequency (RF) reader enabled device. In some embodiments, the project information may include one or more of the physical product's purchase date, manufacturing status, installation date, installed location, model, specification, serial number, project number, maintenance history, and warranty information. In some embodiments, the method may include retrieving the stored project information and providing the retrieved stored project information to a remote computer. In some embodiments, the method may include displaying to the user project information based on the identification data. In some embodiments, the client device may be a smart phone or a tablet. In some embodiments, the product identification tag may be attached to a surface of the physical product. In some embodiments, the product identification tag may be embedded in the physical product.

In some embodiments, a method may include recording details about a project. The project may include installation of one or more physical products. The method may also include for an installed or to be installed physical product, reading identification data from a radio-frequency identification (RFID) tag attached to said physical product with a first radio frequency reader enabled device. The method may also include storing the identification data read from the RFID tag in a data storage. The method may also include associating the identification data read from the RFID tag with project information associated with installation of the physical product stored in the data storage. The method may also include placing a second radio frequency reader enabled device in proximity to one of the one or more physical products. The method may also include reading the identification data from the RFID tag with the second radio frequency reader enabled device. The second radio frequency reader enabled device may have a customer application thereon for instructing a customer in performing the reading. The RFID tag may be attached to the one of the one or more physical products installed at a customer's residence. The method may also include checking the identification data against the stored project information. The method may also include based on the checking, identifying the one of the one or more physical products. The method may also include for the identified one of the one or more physical products, initiating a service or a warranty request.

### BRIEF DESCRIPTION OF THE DRAWINGS

The accompanying drawings, which are incorporated herein and form a part of the specification, illustrate the aspects of the present disclosure and, together with the description, further serve to explain the principles of the aspects and to enable a person skilled in the pertinent art to make and use the aspects. The drawings are for illustration purposes only, show exemplary non-limiting embodiments, and are not necessarily drawn to scale. The detailed descriptions of the example embodiments are to be considered together with the accompanying drawings wherein like numbers refer to like parts and further wherein:

FIG. 1A illustrates a block diagram of one example of a system in accordance with some embodiments.

FIG. 1B illustrates a block diagram of an example of a computing device that may be used in the system illustrated in FIG. 1A in accordance with some embodiments.

FIG. 2 illustrates elements of an exemplary project and data management system and flow in accordance with some embodiments.

FIG. 3 illustrates an exemplary physical product in accordance with some embodiments.

FIG. 4A illustrates a first exemplary graphical user interface for use in an exemplary project and data management system in accordance with some embodiments.

FIG. 4B illustrates a second exemplary graphical user interface for use in an exemplary project and data management system in accordance with some embodiments.

FIG. 4C illustrates a third exemplary graphical user interface for use in an exemplary project and data management system in accordance with some embodiments.

FIG. 5 illustrates a first example of a flow diagram of a method implemented in accordance with some embodiments of an exemplary project and data management system.

FIG. 6 illustrates a second example of a flow diagram of a method implemented in accordance with some embodiments of an exemplary project and data management system.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. As used herein, use of a singular article, such as “a,” “an” and “the,” is not intended to exclude pluralities of the article's object unless the context clearly and unambiguously dictates otherwise. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

Systems and methods are disclosed herein in connection with embodiments of an exemplary project and data management system, specifically one used in a home improvement or remodeling business. As described herein, the systems and methods may be performed, at least in part, with a computing device, such as a phone, tablet, or laptop, to provide only a few non-limiting examples. Information may be stored, such as in a database or other data structure, and associated with a project or job identifier, account, and/or profile of the user.

### System Overview

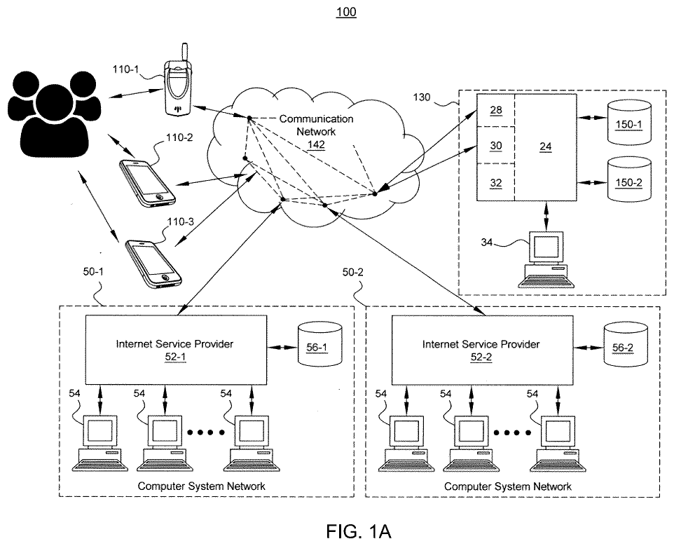

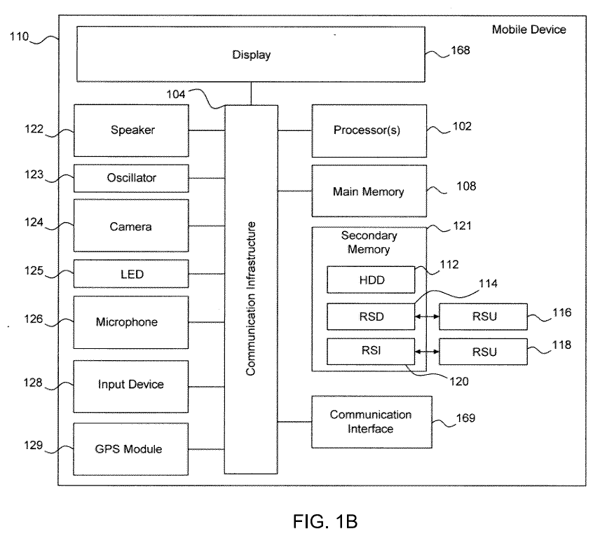

FIG. 1A illustrates one example of a system or environment 100 in which the present invention can be implemented. The system 100 may include a plurality of client devices 110-1, 110-2, and 110-3 (collectively, “client devices 110”), which may be communicatively coupled to one or more computer system networks 50-1, 50-2 (“computer networks 50”) and to management server 130 via communication network 142. Communication network 142 may be a wide area network (“WAN”), a local area network (“LAN”), personal area network (“PAN”), or other communication network as will be understood by one of ordinary skill in the art. In some embodiments, communication network 142 may be the Internet and client devices 110 may be referred to as being online. For example, “online” may mean connecting to or accessing source data or information from a location remote from other devices or networks coupled to communication network 142.

Management server 130 may include a processing unit 24 coupled to one or more data storage units 150-1, 150-2 (collectively, “data storage units 150” or “data storage 150”). Data may be stored in the data storage units 150 in a structured or unstructured manner. For example, data may be stored in a database, such as a relational and/or sequential database, which may be referred to as a database management system (“DBMS”), or data may be stored in an object store, such as using a hash table and/or an S3 protocol. The processing unit 24 may be configured to provide one or more front-end graphical user interfaces (“GUIs”) (e.g., a user GUI 28 and an advisor GUI 30) and one or more back-end or administrative GUIs or portals 32. The GUIs 28, 30, 32 may be accessible to one or more remote computers 54 and/or to one or more local computers 34. The GUIs or portals 28, 30, 32 can take the form of, for example, a webpage that is displayed using a browser program local to remote computers 54 and/or to one or more local computers 34. It should be understood that the management server 130 may be implemented on one or more computers, servers, or other computing devices. In some embodiments, a GUI 28, 30, 32 may be displayed on client devices 110 via a software application, such as an iOS or Android app. For example, system 100 may include additional servers programmed or partitioned based on permitted access to data stored in data storage 150. As used herein, “portal” is not limited to general-purpose Internet portals, such as YAHOO!® or GOOGLE®, but also includes GUIs that are of interest to specific, limited audiences and that provide the party access to a plurality of different kinds of related or unrelated information, links and tools as described below. “Webpage” and “website” may be used interchangeably herein.

Remote computers 54 may be part of a computer system network 50-1, 50-2 and may gain access to communication network 142 through an Internet service provider (“ISP”) 52-1, 52-2 (“ISPs 52”). Client devices 110 may gain access to communications network 142 through wired or wireless connection as will be understood by one skilled in the art, including but not limited to a wireless cellular communication network, a WAN hotspot, a WiFI home network, an ISP, etc. Client users and administrative personnel, as will be described below, may use local computers 34, remote computers 54, and/or client devices 110 to gain access to system 100. Computer system network 50-1, 50-2 may include one or more data storage units 56-1, 56-2 (collectively, “data storage units 56” or “data storage 56”). Data storage units 56 may be similar to the data storage 150 described above, although one of ordinary skill in the art will understand that data storage units 56 may take other forms.

Client devices 110 may be any computing device capable of transmitting and receiving signals via a wired and/or wireless communication medium. Examples of client devices 110 include, but are not limited to, mobile or cellular phones, smart phones, personal digital assistants (“PDAs”), laptop computers, tablet computers, and e-readers, to name a few possible devices.

FIG. 1B is a block diagram of one example of an architecture of a client device 110 in accordance with some embodiments. A client device 110 may include one or more processors, such as processor 102. Processor 102 may be any central processing unit (“CPU”), microprocessor, micro-controller, or computational device or circuit for executing instructions. It should be understood that processor 102 may include multiple processors that perform all or some of the operations in a distributed manner (e.g., in series and/or parallel). Processor 102 may be connected to a communication infrastructure 104 (e.g., a communications bus, crossover bar (or switch), or network). It should be apparent to one of ordinary skill in the art how to implement the method using client devices 110 that include other systems or architectures beyond that set forth in FIG. 1B. Further, one of ordinary skill in the art will understand that computing devices 34, 54 may have a similar and/or identical architecture as that of client devices 110. Put another way, computing devices 34, 54 may include some, all, or additional functional components as those of the client device 110 illustrated in FIG. 1B.

Client device 110 also may include a display 168 that displays graphics, video, text, and other data received from the communication infrastructure 104 (or from a frame buffer not shown) to a user. Examples of such displays 168 include, but are not limited to, LCD screens, OLED display, capacitive touch screen, and a plasma display, to list only a few possible display types. Client device 110 also may include a main memory 108, such as a random access (“RAM”) memory, and a secondary memory 121. Secondary memory 121 may include a more persistent memory such as, for example, a hard disk drive (“HDD”) 112 and/or removable storage drive (“RSD”) 114, which may represent a magnetic tape drive, an optical disk drive, solid-state drive (“SSD”), or other suitable memory. In some embodiments, removable storage drive 114 may read from and/or write to a removable storage unit (“RSU”) 116 in a manner that is understood by one of ordinary skill in the art. Removable storage unit 116 may represent a magnetic tape, optical disk, or the like, which may be read by and written to by removable storage drive 114. As will be understood by one of ordinary skill in the art, the removable storage unit 116 may include a tangible and non-transient machine-readable storage medium having stored therein computer software and/or data.

In some embodiments, secondary memory 121 may include other devices for allowing executable programs or other instructions to be loaded into client device 110. Such devices may include, for example, a removable storage unit (“RSU”) 118 and a corresponding removable storage interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to client device 110.

Client device 110 also may include a speaker 122, an oscillator 123, one or more cameras 124, a light emitting diode (“LED”) 125, a microphone 126, an input device 128, an accelerometer (not shown), and a global positioning system (“GPS”) module 129. Examples of camera 124 features include, but are not limited to optical image stabilization (“OIS”), larger sensors, bright lenses, 4K video, optical zoom plus RAW images and HDR, and “Bokeh mode” with multi lenses and multi-shot night modes, to list a few possible examples. Camera 124 may comprise one or more lenses with different functions. By way of example, camera 124 may include an ultra-wide sensor, telephoto sensor, time of flight sensor, macro sensor, megapixel (“MP”) sensor, and/or a depth sensor. As noted above, camera 124 is not limited to a single camera and includes a camera system that may include multiple different types of cameras, sensors, etc. By way of example, Apple's TrueDepth® camera system may include a front-facing “selfie” camera, an infrared emitter, an infrared camera, a proximity sensor, an ambient light sensor, a flood illuminator, and a dot projector that cooperate to obtain depth map and associated image. In other words, camera 124 of client device 110 may have multiple sensors, cameras, emitters, or other associated components that work as a system to obtain image information for use by client device 110.

Examples of an input device 128 may include, but are not limited to, a keyboard, buttons (physical or virtual), a trackball, voice input (e.g., microphone and corresponding software for recognizing speech), or any other interface or device through which a user may input data. In some embodiments, input device 128 and display 168 may be integrated into the same device. For example, display 168 and input device 128 may be touchscreen through which a user uses a finger, pen, and/or stylus to input data into client device 110.

Client device 110 also may include one or more communication interfaces 169, which allow software and data to be transferred between client device 110 and external devices such as, for example, another client device 110, a computer 34, 54 and other devices that may be locally or remotely connected to client device 110. Examples of the one or more communication interfaces 169 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 169 may also include a wireless interface configured for short range communication, such as RFID including near field communication (“NFC”), Bluetooth, or other interface for communication via another wireless communication protocol. As briefly noted above, one of ordinary skill in the art will understand that computing devices 34, 54 and portions of system 100 may include some or all components of client device 110.

Software and data transferred via the one or more communications interfaces 169 may be in the form of signals, which may be electronic, electromagnetic, optical, and/or other signals capable of being received by communications interfaces 169. These signals may be provided to communications interface 169 via a communications path or channel. The channel may be implemented using wire or cable, fiber optics, a telephone line, a cellular link, a radio frequency (“RF”) link, or other communication channels.

In this application, the terms “non-transitory computer program medium” and “non-transitory computer-readable medium” refer to media such as removable storage units 116, 118, and/or a hard disk installed in hard disk drive 112. These computer program products may provide software to client device 110 and/or other computing devices or processors. Computer programs (also referred to as “computer control logic”) may be stored in main memory 108 and/or secondary memory 121. Computer programs may also be received via the one or more communications interfaces 169. Such computer programs, when executed by a processor(s) 102, may enable the client device 110 to perform the features of the methods and systems discussed herein.

In various embodiments, as shown in FIGS. 1A and 1B, client device 110 may include a computing device such as a hashing computer, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (“OHMDs”)), an embedded computing device (e.g., in communication with a smart textile or electronic fabric), or any other suitable computing device configured to store data and software instructions, execute software instructions to perform operations, and/or display information on a display device. Client device 110 may be associated with one or more users (not shown). For example, a user may operate client device 110 causing it to perform one or more operations in accordance with various embodiments.

In embodiments where some or all of the system 100 or methods performed by one or more components of the system 100, which may be partially or entirely implemented using software, the software may be stored in a computer program product and loaded into a computing device 34, 54, a client device 110, and/or management server 130 using removable storage drive 114, hard drive 112, and/or communications interface 169. The software, when executed by one or more processor, causes the one or more processor to perform the functions of the method described herein. In some embodiments, the methods may be implemented primarily in hardware using, for example, hardware components, such as application specific integrated circuits (“ASICs”). Implementation of the hardware state machine to perform the functions described herein will be understood by persons skilled in the art. In some embodiments, the methods may be implemented using a combination of both hardware and software.

Embodiments of the subject matter described in this specification can be implemented in a system 100 that includes a back end component, e.g., as a data server, or that includes a middleware component, e.g., an application server, or that includes a front end component (e.g., a client device 110) having a graphical user interface or a Web browser through which a user can interact with an implementation of the subject matter described is this specification, or any combination of one or more such back end, middleware, or front end components. The components of the system can be interconnected by any form or medium of digital data communication, (e.g., a communication network 142). Communications network 142 may include one or more communication networks or media of digital data communication. Examples of communication network 142 include a local area network (“LAN”), a wireless LAN (e.g., a “WiFi” network), a RF network, a NFC network, a wireless Metropolitan Area Network (“MAN”) connecting multiple wireless LANs, NFC communication link(s), and a wide area network (“WAN”), e.g., the Internet and combinations thereof. In accordance with various embodiments, communications network 142 may include the Internet and any publicly accessible network or networks interconnected via one or more communication protocols, including, but not limited to, HyperText Transfer Protocol (“HTTP”), HyperText Transfer Protocol Secured (“HTTPS”), Secured Socket Layer/Transport Layer Security (“SSL/TLS”), and transmission control protocol/internet protocol (“TCP/IP”). Communications protocols in accordance with various embodiments also include protocols facilitating data transfer using radio frequency identification (“RFID”) communications, such as NFC. Moreover, communications network 142 may also include one or more mobile device networks, such as a GSM or LTE network, or a PCS network, allowing a client device to send and receive data via applicable communications protocols, including those described herein. For case of illustration, communication network 142 is shown as an extension of management server 130.

A client device 110 and management server 130 are generally remote from each other and typically interact through a communication network 142. The relationship of client device 110 and management server 130 may arise by virtue of computer programs running on the respective system components and having a client-server relationship to each other. System 100 may include a web/application server (not shown) in embodiments used to gain access to many services provided by management server 130.

In some aspects, a client device 110 may store in memory one or more software applications that run on the client device when executed by the one or more processors 102 of the client device 110. In some instances, each client device 110 may store software applications that, when executed by one or more processors 102, perform operations that establish communications with management server 130 (e.g., across communication network 142 via communication interface 169) and that obtain, from management server 130, information or data from the data stores 150 in accordance with various embodiments.

In various embodiments, client device 110 may execute stored software application(s) to interact with management server 130 via a network connection. The executed software applications may cause client device 110 to communicate information (e.g., measurements, user profile information, device information, and/or other information). Software applications(s) may be configured to allow a user associated with client device 110 to obtain one or more measurements using a camera 124. Stored software application(s) on client device 110 may be configured to access webpages on the Internet or other suitable network based communication capable of interacting with communication network 142, as will be understood by one of ordinary skill in the art. For example, a user may access a user account on management server 130 via an Internet webpage. The management server 130 may be configured to render the Internet webpage for the user on client device 110. Alternatively or additionally, management server 130 may provide information to stored software application(s) on client device 110 via communication network 142. The client device 110 may display information provided by management server 130 using a stored software application(s) graphical user interface display. A respective user account may be associated with a developer, client user, or supervisor/monitoring authority as will be understood by one of ordinary skill in the art and described below.

As noted herein, system 100 may include data stores 150, which may be configured to store and manage data, such as customer project information, which may include one or more physical product's purchase date, manufacturing status, installation date, installed location, model, specification, serial number, project number, maintenance history, or warranty information, user account authentication information, and other data maintained by the management server 130. The data stores 150 may be communicatively coupled with various modules and engines as will be understood by one of ordinary skill in the art.

It should be understood that various forms of data storage or repositories can be used in system 100 that may be accessed by a computing system, such as hard drives, tape drives, flash memory, random-access memory, read-only memory, EEPROM storage, in-memory databases like SAP HANA, and so on, as well as any combination thereof. Stored data may be formatted within data stores 150 in one or more formats, such as flat text file storage, relational databases, non-relational databases, XML, JSON, comma-separated values, Microsoft Excel files, or any other format known to those of ordinary skill in the art, as well as any combination thereof as is appropriate for the particular use. Data stores 150 may provide various forms of access to the stored data, such as by file system access, network access, S3, a SQL protocol (e.g., ODBC), HTTP, FTP, NES, CIFS, and so on, as well as any combination thereof.

According to various embodiments, client device 110 may be configured to access data storage 150 via management server 130. In various embodiments, the data storage 150 may be configured to maintain a database schema. For example, a database schema may be arranged to maintain identifiers in columns within data storage 150 associated with customer project data and/or physical product identification information. In this aspect, identifiers may refer to specific information pertaining to the categories described above. A database schema within the data storage 150 may be arranged or organized in any suitable manner within the system. Although the above-described examples identify categorical identifiers, any number of suitable identifiers may be used to maintain records associated with the system described herein. In addition, a database schema may contain additional categories and identifiers not described above for maintaining record data in system 100. The database can also provide statistics and marketing information associated with users of system 100. A database schema may advantageously organize identifiers in a way that permits the system to operate more efficiently. In some embodiments, categories of identifiers in the database schema increase efficiency by grouping identifiers with an associated management model of management server 130.

In some embodiments, data may be stored as a block or blob in an object store that is accessible using one or more identifiers. For example, the object may include various types of information associated with a user, project, and/or physical product, and may be accessed using a hash or other unique (or substantially unique) value. One of ordinary skill in the art will understand that the data storage 150 may be configured in a number of ways to facilitate data storage and retrieval.

In various embodiments, management server 130 may include computing components configured to store, maintain, and generate data and software instructions. For example, management server 130 may include or have access to one or more processors 24, one or more servers (not shown) and tangible, non-transitory memory devices for storing software or code for execution and/or additional data stores. Servers may include one or more computing devices configured to execute software instructions stored on to perform one or more processes in accordance with various embodiments. In some embodiments, data storage 150 may include or be associated with a server that executes software instructions to perform operations that provide information to at least one other component of computing environment 100, for example providing data to another data store or to third party recipients (e.g., local computer 34, computer system network 50, client device 110, third party vendors, information gathering institutions, etc.) through a network, such as a communication network 142.

Management server 130 may be configured to provide one or more websites, digital portals, or any other suitable service that may be configured to perform various functions of management server 130 components. In some embodiments, management server 130 may maintain one or more application programming interfaces (“APIs”) through which the functionality and services provided by server 130 may be accessed through one or more application programs executed by a computing device 34, 54, 110. In various embodiments, management server 130 may provide information to software application(s) on client device 110 for display on a graphical user interface (e.g., such as on display 168).

In some embodiments, management server 130 provides information to client device 110 (e.g., through the API associated with the executed application program). Client device 110 presents portions of the information to corresponding users through a corresponding respective graphical user interface or webpage on display 168.

In various embodiments, management server 130 may be configured to provide and/or receive information associated with services provided by management server 130. For example, client device 110 may receive information from management server 130 via communication network 142, which may be stored in a locally accessible store device and/or network-accessible storage devices and data stores (e.g., cloud-based storage). For example, client device 110 may execute stored instructions (e.g., an application program, a web browser, and/or a mobile application) to process portions of stored data and render portions of the stored data for presentation to the respective user or users. Management server 130 may include additional servers (not shown), which may be incorporated as a corresponding node in a distributed network or as a corresponding networked server in a cloud-computing environment. Furthermore, servers may communicate via communication network 142 with one or more additional servers (not shown) that may facilitate the distribution of processes for parallel execution by the additional servers.

### Application Overview

In some embodiments, a radio-frequency identification (RFID)-based product identification and digitalization system is provided for non-digital products. While described in connection with window products, the invention is not so limited, and may be used in connection with any physical product where it is advantageous to give that physical product a digital representation in a project or account tracking system. The systems and methods described herein effectively turn non-digital (physical) products into smart consumer products and give the non-digital product a digital representation, which can expedite or even enable automation of a business's service with respect to that physical product.

RFID uses electromagnetic fields to automatically identify and track tags attached to objects. An RFID system comprises a small radio transponder, a radio receiver and transmitter. When triggered by an electromagnetic interrogation pulse from a nearby RFID reader device, the tag transmits digital data, usually an identifying inventory or serial number, back to the reader. This number can be used to track physical products for purposes such as inventory, service, and warranty information. Passive tags are powered by energy from the RFID reader's interrogating radio waves. Active tags are powered by a battery and thus can be read at a greater range from the RFID reader, such as up to hundreds of meters. In certain embodiments described herein, the RFID tag is a passive tag though this is not a requirement and active tags may be used. A typical RFID tag includes a microchip (e.g., an integrated circuit which stores and processes information and modulates and demodulates radio-frequency (RF) signals), an antenna for receiving and transmitting the signal and a substrate. The tag information is stored in a non-volatile memory. The RFID tag includes either fixed or programmable logic for processing the transmission and sensor data, respectively.

In some embodiments, the RFID tag may be the NTAG 215 NFC Forum Type 2 Tag Compliant IC available from NXP Semiconductors, which can be read by any NFC device or NFC-compliant Proximity Coupling Device. The tag is compliant with NFC Forum Type 2 Tag and ISO/IEC14443 Type A specifications. Selected technical details provided by the manufacturer associated with this tag may include:
1. Contactless transmission of data and supply energy;
2. Operating frequency of 13.56 MHz;
3. Data transfer of 106 kbit/s;
4. Data integrity of 16-bit CRC, parity, bit coding, bit counting;
5. Operating distance up to 100 mm (depending on various parameters such as, e.g., field strength, antenna geometry, etc.);
6. 7-byte serial number (cascade level 2 according to ISO/IEC 14443-3);
7. UID ASCII mirror for automatic serialization of NDEF messages;
8. Automatic NFC counter triggered at a reading command;
9. NFC counter ASCII mirror for automatic adding the NFC counter value to the NDEF message;
10. ECC-based originality signature;
11. Fast read command;
12. True anti-collision;
13. 50 pF input capacitance;
14. 180, 540, or 924 bytes organized in 45, 135, or 231 pages with 4 bytes per page;
15. 144, 504, or 888 bytes freely available user Read/Write area (36, 126 or 222 pages);
16. 4 bytes initialized capability container with one-time programmable access bits;
17. Field programmable read-only locking function per page for the first 16 pages;
18. Field programmable read-only locking function above the first 16 pages per double page for NTAG 213 or per 16 pages for NTAG 215 and NTAG 216;
19. Configurable password protection with an optional limit of unsuccessful attempts;
20. Anti-tearing support for capability container (CC) and lock bits;
21. ECC supported originality check;
22. Data retention time of 10 years; and
23. Write endurance 100,000 cycles

In embodiments described herein, the system leverages RFID technology, a mobile application (e.g., resident on a client device 110), and a backend project and data management system (e.g., implemented in one or more management servers 130) to provide a seamless and efficient solution for identifying, monitoring, and digitalizing non-digital products, such as windows, doors, solar panels, roofing tiles, or other products installed in a home (or business) as part of a home-improvement, repair, or new construction project. In some embodiments, the system enhances the management of non-digital products (e.g., windows) in the residential construction industry, but is not so limited, having use-cases for various industries. As described herein, the system operates to convert physical non-digital products into digital representations for improved inventory control, warranty management, and sales tracking.

Embodiments of the system permit customers to identify non-digital products at their home and create a service ticket with the business (e.g., for warranty or non-warranty purposes) within seconds. The system then permits the business to immediately and efficiently identify the customer's non-digital products, eliminating the need for human in-person inspection of the non-digital products, expediting its services, and also facilitating the business's ability to aggregate performance metrics for non-digital products.

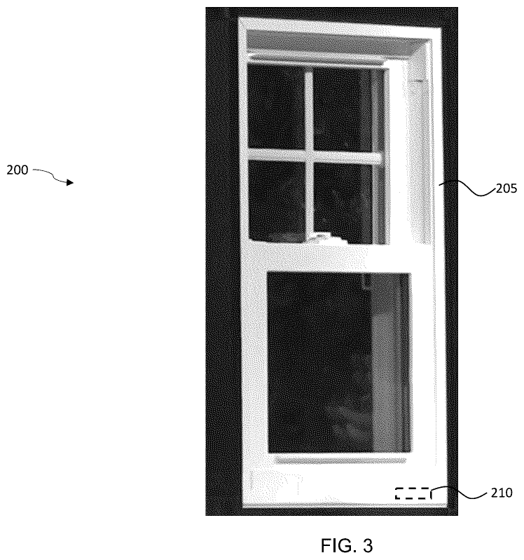

In some embodiments, an RFID tag is affixed during or after manufacturing of each non-digital product (e.g., to a window as illustrated in FIG. 3 and discussed in more detail below). As part of a project (e.g., replacing windows in a home with new windows), the product is installed. Items of data about the project (e.g., home address, customer identification data, installation date, products installed (e.g., window), product model and details (e.g., manufacturer, type of window), product location (e.g., first floor bathroom), installer, warranty information including dates and scope, and any other relevant project information) and RFID information for each installed product (e.g., unique (e.g., in the scope of the system) RFID tag number) are entered and stored in the backend project and data management system. The customer downloads and stores on his or her smartphone (for example) an application that serves as customer interface or portal to the customer's account portion of the backend project and management system. This application is configured to access and use RFID reader capabilities resident on the customer's device. When brought into proximity with the window, which has an RFID tag embedded or attached to it (e.g., attached to a surface of the physical product), the application automatically scans the RFID tag to retrieve identification data stored on the tag. This identification data is then transmitted by the application on the customer's device, through a communication network (e.g., communication network 142), to the backend project and data management system, which contains a digital representations of the non-digital product (e.g., product specific details of the installed product, product specifications, maintenance history, warranty information, etc.).

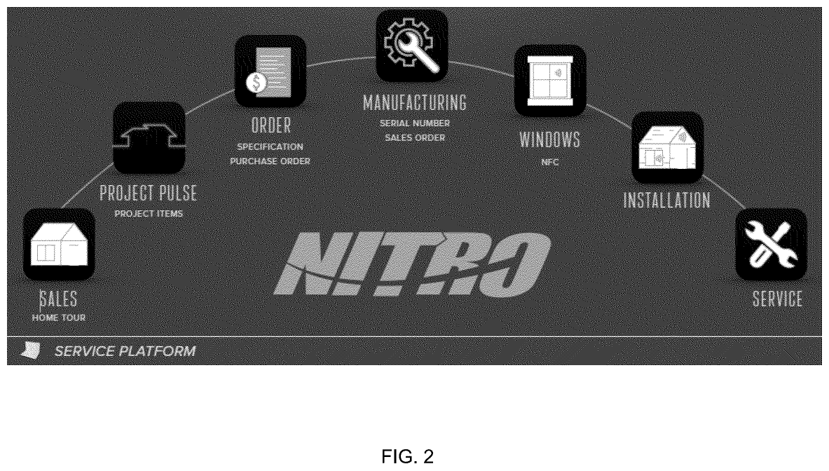

FIG. 2 illustrates the life of a home improvement project that is tracked using the project and data management system, for example the NITRO™ Service Platform of the present assignee. In some embodiments, various aspects of the process reflected in FIG. 2 correspond to functional modules of the project and management system and data stored therein.

The “Sales” element reflects the starting point of sale where the customer gains access to the mobile application (called PROJECT PULSE™ application in the assignee's system). At the customer order phase, serial numbers are generated for each product purchased by the customer (e.g., each individual window, door, solar panel, etc.). These serial numbers may be assigned by the manufacturer or the business. Each product serial number is used to create a digital representation (described above) of the individual non-digital product ordered by the customer within the project and data management system. The “Order” element reflects that when the customer orders the product, a purchase order is created and the order details (products ordered, each product's serial number, project information, etc. as described above) is stored in the project and data management system. Thereafter, the products (e.g., a custom window) are manufactured as reflected by the “Manufacturing” element. In the project and data management system, each product is associated with sales order and the serial number (which serves as a unique identifier of an individual physical product in the system) assigned to the product. As part of the manufacturing process (or alternatively during installation) an RFID tag is attached, embedded in, or otherwise included with each product. This is reflected by the “Windows-NFC” element. The next phase is represented by the “Installation” element. During the product installation phase, the business validates the serial number of the non-digital product in the project and data management system. By “validate”, it is meant that the RFID tag attached to a given physical product (e.g., a window) is read (e.g., by the installer) to obtain that RFID tag's unique identifier and then that RFID tag unique identifier is associated with the product's assigned serial number in the project and data management system. In an alternative embodiment, the read RFID tag's unique identifier is populated into the project and data management system and serves as the product serial number associated with the individual product in the project data.

Returning to the “Manufacturing” element, in embodiments, the customer can track the manufacturing process and status using the customer application.

During the lifecycle of the transaction—from the point of sale through the life of the warranty (potentially years after the installation)—the customer application in combination with the project and data management system permits the customer to identify the non-digital product and initiate service tickets as illustrated by the “Service” element.

FIG. 3 illustrates an exemplary physical product 200 in accordance with some embodiments. The physical product 200 may be a double hung window 205. The double hung window 205 may include a product identification tag 210 that is attached to or embedded in the window 205. For example, new physical products 200 (e.g., window 205) may have a product identification tag 210 that is embedded in the physical product 200. As another example, already existing (and not yet installed) and already installed physical products 200 may have a product identification tag 210 that is attached to the physical product 200, such as with one or more fasteners (e.g., nail, screw, staple, etc.), adhesive, hook and loop fastener, or some other suitable permanent or temporary fixation mechanism.

A customer (or current owner) of the building where the window 205 is installed may use the customer application as described above. For example, an installed window 205 may have a perceived defect, such as a leak. The customer can launch the customer application on the customer's smartphone and then bring the smartphone close to the window 205 within reading distance of the window's product identification tag 210. The smartphone, using its RFID reader, reads the RFID product identification tag 210 and transmits the read information to the project and data management system (e.g., such as through system 100). The transmitted information is then used (e.g., as an index) alone or with other information about the project stored in the system to identify the specific physical product (e.g., window 205) that the customer scanned. From that point, the application can be used by the customer to initiate a warranty and/or service request with the business for the specific physical product. From the business' perspective, the process permits the business to efficiently perform service calls and/or warranty services, with no potential confusion as to the specific physical product at issue and its installed location in the home, all without a physical visit to the product's location, and track the performance of the product individually in a specific home, as well as more globally, i.e., the performance of a class of physical products across multiple homes by aggregating the data.

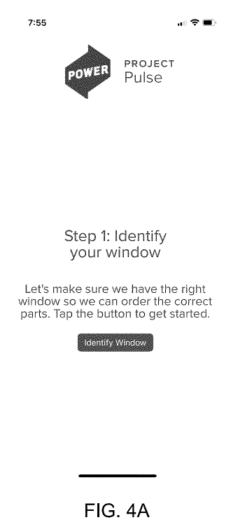

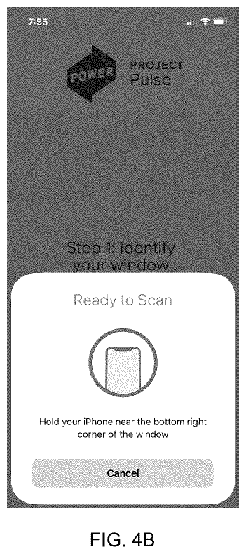

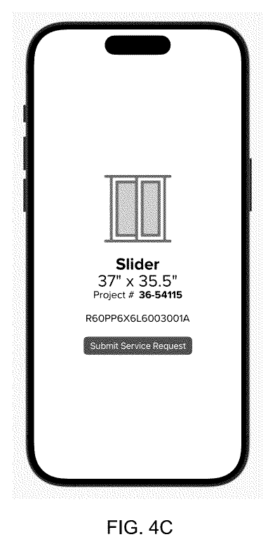

FIGS. 4A-C illustrate examples of GUIs presented to a customer through the customer application of the system (e.g., PROJECT PULSE™ application of the present assignee) on the customer's device. Referring first to FIG. 4A, after launching the application, the customer selects an option that involves or requires identification of a physical product (such as the window 205). For example, this option may be in the warranty service option of the customer application. Selecting this option presents the GUI of FIG. 4A, which is used to guide the customer though identifying the window 205. The GUI includes a selectable (e.g., by touching) option button labeled “Identify Window”. Selecting the button causes the application to access and use the RFID reader resident on the customer's device (e.g., such as client device 110) and brings up the GUI shown in FIG. 4B. The GUI of FIG. 4B instructs or otherwise prompts the customer on positioning the device with respect to (proximate to) the physical product 200, e.g.: “Hold your iPhone near the bottom right corner of the window”. Once the device is brought within reading range of the RFID tag 210 on the window 205, the device reads the information (e.g., identification number) stored on the RFID tag 210. Next, the application sends the retrieved information to the backend system, which checks the information against the data stored in the system to identify the specific physical product that the customer scanned. In an alternative, in advance of scanning, the customer's application can pull data from the backend system (e.g., data associated with a project from the management server 130) and store that data locally such that it can be checked against the information read from the RFID tag 210. In either case, a next GUI displayed to the customer is shown in FIG. 4C. The information pulled from the RFID tag 210 was used to identify the specific physical product 200 that the was read. In the illustrated GUI, the window 205 is a Slider that is 37″×35.5″. The project associated with its install is Project #36-54115. The window 205 had been assigned serial number R60PP6X6L6003001A, e.g., as part of the product ordering process. The GUI illustrated in FIG. 4C also includes a selectable option (button) labeled “Submit Service Request”. Selecting that button can optionally prompt the customer to enter (e.g., via one or more other GUIs) information about the request, such as a description of the issue, optimal times to service the request, updated contact information, or any other relevant information, or simply submit the service request after which the business can contact the customer, e.g., through the application, by email, by phone, or any other suitable manner.

It should be appreciated that the customer may have several windows 205 (e.g., dozens) and/or other physical products 200 installed in the home, which may even be the subject of multiple, separate projects performed at different times and with different service and warranty terms. After years, the customer may have lost project information (e.g., project paperwork) or may not even be the original customer (or home owner). Also, physical identification information on the windows 205 (e.g., stickers with serial numbers) may not exist or be unreadable with the passage of time. All the customer may know is that a particular business installed the product. Use of the present solution eliminates the onerous and error prone process of individually identifying products from amongst multiple products and accurately conveying that information to the business as well as initiating some service request (or other request) in connection with the individual physical product 200. The solution also alleviates the need for the business to make an initial time consuming and expensive service trip to the customer's premise for purposes of identifying the actual physical product 200 that is the subject of the customer's service request.

As described herein, the RFID-based product identification and digitalization system for non-digital products has the ability to transform the way non-digital products are managed and monitored. The solution has applicability across diverse industries that have demands for efficiency and accuracy. The solution's global scalability makes it an attractive solution for businesses seeking to modernize their operations, improve customer service, and gain a competitive advantage in an increasingly digital world. The solution has applicability across various industries. By way of example only, one such industry is Manufacturing and Construction: Industries that produce and install non-digital products like window sashes (e.g., window 205), doors, building materials, and industrial equipment can benefit significantly. The system can streamline inventory management, improve quality control, and enhance supply chain efficiency. Another example is Retail: Retailers dealing with non-digital products, such as furniture, appliances, and fixtures, can enhance inventory accuracy and customer service. It enables retailers to offer warranties and track product performance efficiently. Another example is Maintenance and Repair Services: Companies providing maintenance and repair services for non-digital products can use the system to maintain records, track warranty coverage, and schedule maintenance more effectively.

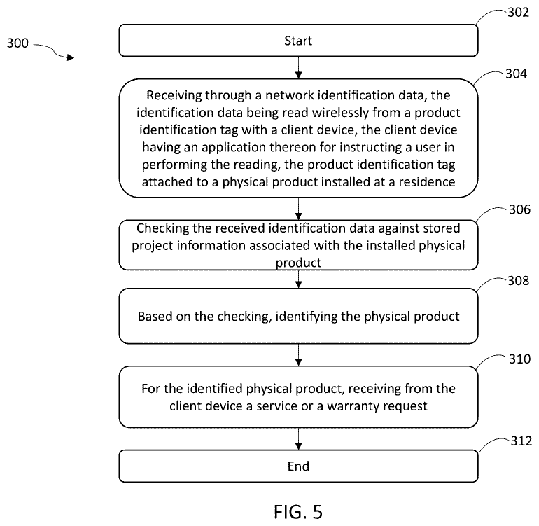

FIG. 5 illustrates a first example of a flow diagram of a method 300 implemented in accordance with some embodiments of an exemplary project and data management system. The method 300 may start at block 302. At block 304, the method 300 may comprise receiving through a network 142 identification data, the identification data being read wirelessly from a product identification tag 210 with a client device 110. The client device 110 may have an application thereon for instructing a user in performing the reading. The product identification tag 210 may be attached to a physical product 200 installed at a residence. Block 306 may comprise checking the received identification data against stored project information associated with the installed physical product 200. Block 308 may comprise based on the checking, identifying the physical product 200. Block 310 may comprise for the identified physical product 200, receiving from the client device 110 initiating a service or a warranty request. The method 300 may end at block 312.

In some embodiments, the method 300 may include retrieving the stored project information and providing the retrieved stored project information to a remote computer 54. In some embodiments, the method 300 may include displaying to the user project information based on the identification data.

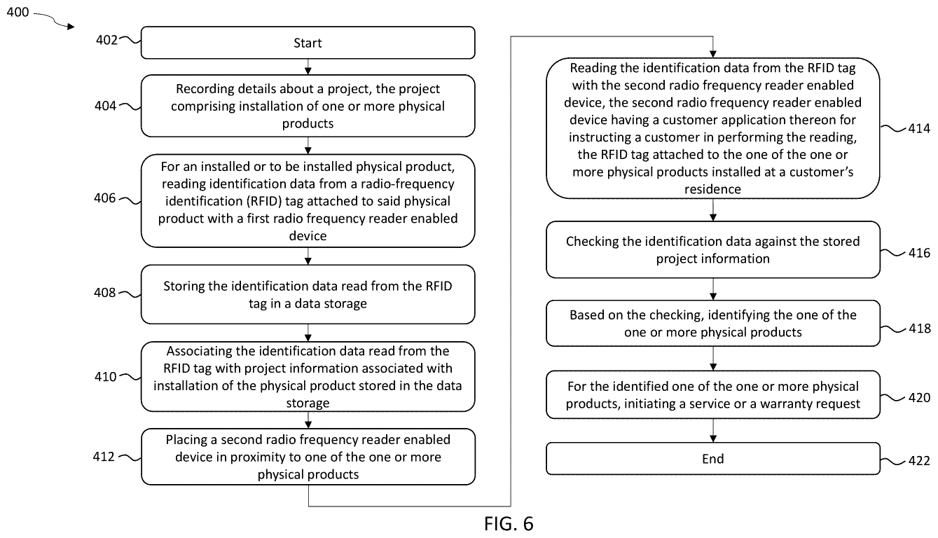

FIG. 6 illustrates a second example of a flow diagram of a method 400 implemented in accordance with some embodiments of an exemplary project and data management system. The method 400 may start at block 402. At block 404, the method 400 may comprise recording details about a project. The project may include installation of one or more physical products 200. At block 406, after the installation (or at another time as part of the installation process) of the one or more physical products 200, the method 400 may include for an installed or to be installed physical product 200, reading identification data from a radio-frequency identification (RFID) tag 210 attached to said physical product 200 with a first radio frequency reader enabled device 110. Block 408 may comprise storing the identification data read from the RFID tag 210 in a data storage 150. Block 410 may comprise associating the identification data read from the RFID tag 210 with project information associated with installation of the physical product 200 stored in the data storage 150. Block 412 may comprise placing a second radio frequency reader enabled device 110 in proximity to one of the one or more physical products 200. Block 414 may comprise reading the identification data from the RFID tag 210 with the second radio frequency reader enabled device 110. The second radio frequency reader enabled device 110 may have a customer application thereon for instructing a customer in performing the reading. The RFID tag 210 may be attached to the one of the one or more physical products 200 installed at a customer's residence. Block 416 may comprise checking the identification data against the stored customer project information. Block 418 may comprise based on the checking, identifying the one of the one or more physical products 200. Block 420 may comprise for the identified one of the one or more physical products 200, initiating a service or a warranty request. The method 400 may end at block 422.

Benefits of the solution described herein include:
Efficiency and Accuracy: The solution has the ability to streamline inventory management, reduce manual data entry errors, and enhance accuracy.
Warranty Management: Businesses can provide better service capabilities and warranty services, improving customer satisfaction and loyalty.
Digitalization Trends: As industries increasingly adopt digital solutions, there is a growing demand for converting non-digital products into digital representations.

Moreover, the system offers a competitive edge to businesses that adopt it, as it enhances operational efficiency, reduces costs, and improves customer satisfaction. The RFID-based system is not limited by geographic boundaries. It can be implemented worldwide, catering to diverse industries and markets. The system is scalable, allowing both small and large businesses to adopt it.

Aspects of the present disclosure can be embodied in the form of methods and apparatuses for practicing those methods. The present disclosure can also be embodied in the form of program code embodied in tangible media, such as secure digital (“SD”) cards, USB flash drives, diskettes, CD-ROMs, DVD-ROMs, Blu-ray disks, hard drives, or any other non-transitory machine-readable storage medium, wherein, when the program code is loaded into and executed by a machine, such as a computer or processor, the machine or processor becomes an apparatus for practicing the disclosure. The present disclosure can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer or processor, the machine becomes an apparatus for practicing the disclosure. When implemented on a general-purpose processor, the program code segments combine with the processor to provide a unique device that operates analogously to specific logic circuits.

The above-described embodiments are merely possible examples of implementations, and merely set forth a clear understanding of the principles of the disclosure. Many variations and modifications may be made to the above-described embodiments and examples of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any disclosure or of what may be claimed, but rather as descriptions of features that may be specific to particular embodiments or examples of particular disclosures. Certain features that are described in this specification in the context of separate embodiments or examples may also be implemented in combination in a single embodiment or example. Conversely, various features that are described in the context of a single embodiment may also be implemented in multiple embodiments or examples separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art.

What is claimed is:

1. A system comprising:
a physical product having a product identification tag, the product identification tag being configured to wirelessly transmit identification data associated with the physical product;
a management server, the management server storing project information associated with the physical product and associating the identification data with the project information; and
one or more client devices communicatively coupled to the management server, the one or more client devices being configured to wirelessly obtain the identification data from the product identification tag when in proximity to the product identification tag and communicate the identification data to the management server.

2. The system of claim 1, wherein the physical product is a window installed at a customer location.

3. The system of claim 1, wherein the product identification tag is a radio-frequency identification (RFID) tag and the one or more client devices are a radio frequency (RF) reader enabled device.

4. The system of claim 1, wherein the project information includes one or more of the physical product's purchase date, manufacturing status, installation date, installed location, model, specification, serial number, project number, maintenance history, and warranty information.

5. The system of claim 1, wherein the one or more client devices include a software application for execution on a smart phone or a tablet.

6. The system of claim 5, wherein the software application includes a service or a warranty service request feature.

7. The system of claim 6, wherein the one or more client devices are configured to display to a user the project information retrieved by the management server using the identification data.

8. The system of claim 1, wherein the one or more client devices is a smart phone or a tablet.

9. The system of claim 1, wherein the product identification tag is attached to a surface of the physical product.

10. The system of claim 1, wherein the product identification tag is embedded in the physical product.

11. A method comprising:
receiving through a network identification data, the identification data being read wirelessly from a product identification tag with a client device, the client device having an application thereon for instructing a user in performing the reading, the product identification tag attached to a physical product installed at a residence;
checking the received identification data against stored project information associated with the installed physical product;
based on the checking, identifying the physical product; and
for the identified physical product, receiving from the client device a service or a warranty request.

12. The method of claim 11, wherein the physical product is a window.

13. The method of claim 11, wherein the product identification tag is a radio-frequency identification (RFID) tag and the client device is a radio frequency (RF) reader enabled device.

14. The method of claim 11, wherein the project information includes one or more of the physical product's purchase date, manufacturing status, installation date, installed location, model, specification, serial number, project number, maintenance history, and warranty information.

15. The method of claim 11, further comprising retrieving the stored project information and providing the retrieved stored project information to a remote computer.

16. The method of claim 11, further comprising displaying to the user project information based on the identification data.

17. The method of claim 11, wherein the client device is a smart phone or a tablet.

18. The method of claim 11, wherein the product identification tag is attached to a surface of the physical product.

19. The method of claim 11, wherein the product identification tag is embedded in the physical product.

20. A method comprising:
recording details about a project, the project comprising installation of one or more physical products;
for an installed or to be installed physical product, reading identification data from a radio-frequency identification (RFID) tag attached to said physical product with a first radio frequency reader enabled device;
storing the identification data read from the RFID tag in a data storage;
associating the identification data read from the RFID tag with project information associated with installation of the physical product stored in the data storage;
placing a second radio frequency reader enabled device in proximity to one of the one or more physical products;
reading the identification data from the RFID tag with the second radio frequency reader enabled device, the second radio frequency reader enabled device having a customer application thereon for instructing a customer in performing the reading, the RFID tag attached to the one of the one or more physical products installed at a customer's residence;
checking the identification data against the stored project information;
based on the checking, identifying the one of the one or more physical products; and
for the identified one of the one or more physical products, initiating a service or a warranty request.
